(19) United States
(12) Patent Application Publication
(10) Pub. No.: US 2018/0203111 A1
(43) Pub. Date: Jul. 19, 2018

(54) WARNING SYSTEM FOR HIGH SPEED APPROACHING DETECTION

(71) Applicant: CUBTEK INC., Zhubei City (TW)

(72) Inventors: SAN-CHUAN YU, Zhubei City (TW); CHI-YU HUNG, Zhubei City (TW); JYONG LIN, Zhubei City (TW)

(21) Appl. No.: 15/869,616

(22) Filed: Jan. 12, 2018

(30) Foreign Application Priority Data
Jan. 13, 2017 (TW) 106101300

(51) Int. Cl. G01S 13/93; G01S 13/91; B60Q 9/00; G08G 1/16; G08G 1/0967

(52) U.S. Cl. CPC G01S 13/931; G01S 13/91; B60Q 9/008; G01S 2013/9353; G08G 1/165; G08G 1/096766; G01S 2013/9357; G08G 1/166

(57) ABSTRACT

A warning system for high speed approaching detection, includes a statically placed detection device a warning device electrically connected with the detection device. The detection device applies a radar detection module and a central processing module to detect and calculate the speed or distance of an approaching object, and determines if a risk threshold value is exceeded through a threshold determination unit, so as to send the warning by the warning device. The warning system is applicable to a statically placed traffic cone or warning sign for notifying the user of a fast approaching object through the warning device, thereby preventing or reducing possible damage. Also, the present invention is applicable to roadside check for the police, so as to reduce the risk of damage due to an unaware dashing of vehicles during the roadside check execution.

### BACKGROUND OF THE INVENTION

### Field of the Invention

The present invention relates to warning systems, and more particularly, to a warning system for high speed approaching detection.

### Description of the Related Art

Radar detection systems are extensively applied to the advanced driver assistance system (ADAS) of intelligent vehicles, such as blind spot detection systems, rear crash collision warning systems, and pre-crash systems. The application of such assistance systems provides assistance to the drivers for determining the driving conditions, so as to improve the traffic security.

Such radar assistance systems are applied for preventing the vehicle of the user from collision. However, when a vehicle which is broken down stops at the roadside, other vehicles approaching from behind often accidentally collides the broken down vehicle, causing the injury or even death of the people inside or beside the broken down vehicle. Additionally, when the police places barricades at the road for executing a roadside check or applies a vehicle body as a cover for conducting a strike operation at a crime scene, policemen are often hurt by the collision of the vehicle body due to the unawareness upon other fast approaching vehicles. Therefore, it is desirable to resolve the issues of casualty caused by fast approaching object under a static status for the industry.

### SUMMARY OF THE INVENTION

For improving the issues above, the present invention aims at resolving the incapability of detecting the risk of a fast approaching object and warning in advance.

For achieving the aforementioned objectives, a warning system for high speed approaching detection in accordance with an embodiment of the present invention is provided, comprising a statically placed detection device and a warning device electrically connected with the detection device. The detection device comprises a main body; a radar detection module disposed at the main body; a central processing module electrically connected with the radar detection module; and a first message transmission module electrically connected with the central processing module. The central processing module includes a speed calculation unit and a threshold determination unit. The central processing module receives a detection signal from the radar detection module, and acquires an approaching speed information of an approaching object through the speed calculation unit. The threshold determination unit determines if a warning is to be sent to the first message transmission module according to the approaching speed information. The warning device comprises a second message transmission module and a warning module connected with the second message transmission module.

Also, the central processing module is allowed to be disposed in the warning device, such that the detection device is simply applied for detecting and sending the detected signal. Therefore, a warning system for high speed approaching detection in accordance with another embodiment of the present invention is further provided, comprising a statically placed detection device and a warning device electrically connected with the detection device. The detection device comprises a main body; a radar detection module disposed at the main body; and a first message transmission module electrically connected with the radar detection module. The warning device comprises a second message transmission module, a central processing module electrically connected with the second message transmission module, and a warning module electrically connected with the central processing module. The central processing module includes a speed calculation unit and a threshold determination unit. The central processing module receives a detection signal from the radar detection module through the second message transmission module, and acquires an approaching speed information of an approaching object through the speed calculation unit. The threshold determination unit determines if a warning is to be sent to the warning module according to the approaching speed information.

Furthermore, in addition to acquiring the approaching speed of an approaching object through the speed calculation unit for determining if the signal shall be sent, the present invention applies a distance calculation unit to acquire the approaching distance information, such that the threshold determination unit determines if the warning shall be sent according to the approaching distance information.

With such configuration, the present invention achieves following advantages.

By detecting the risk of an approaching object through the detection device, a warning function is provided for the user who is unable to be aware of other approaching objects.

Also, by understanding the approaching speed or distance through the central processing module, an approaching risk is detected, so as to send out the warning to notify the user of a fast approaching risk.

### BRIEF DESCRIPTION OF THE DRAWINGS

FIG. 1 is a schematic view of the system module in accordance with an embodiment of the present invention.

FIG. 2 is a schematic view of the system module in accordance with a second embodiment of the present invention.

FIG. 3 is a first schematic view illustrating an operation status in accordance with a preferred embodiment of the present invention.

FIG. 4 is a second schematic view illustrating an operation status in accordance with another preferred embodiment of the present invention.

FIG. 5 is a third schematic view illustrating an operation status in accordance with another preferred embodiment of the present invention.

FIG. 6 is a schematic view of the system module in accordance with a third embodiment of the present invention.

FIG. 7 is a schematic view of the system module in accordance with a fourth embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

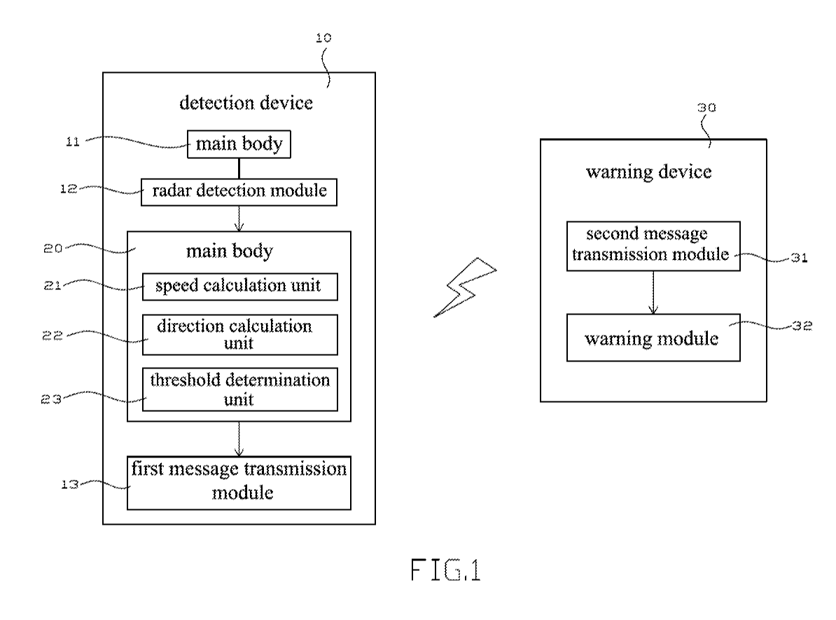

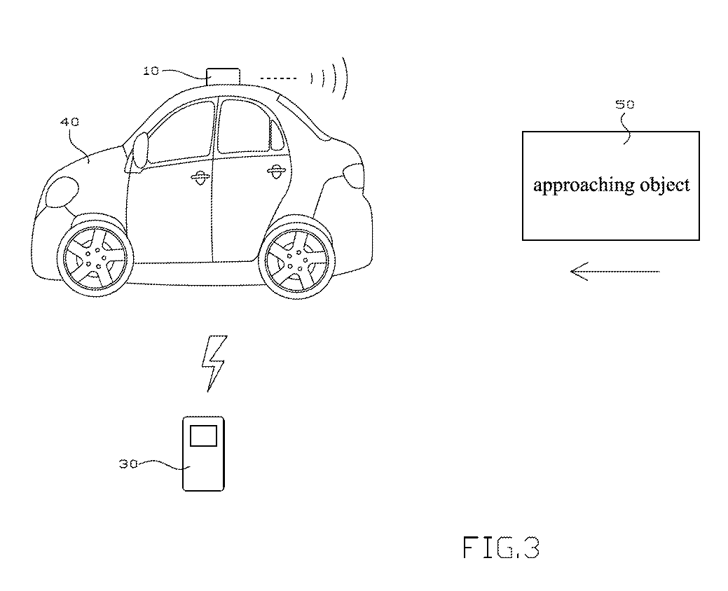

Referring to FIG. 1 and FIG. 3, a warning system for high speed approaching detection in accordance with an embodiment of the present invention comprises a statically placed detection device 10 and a warning device 30 electrically connected with the detection device 10. The detection device 10 includes a main body 11, a radar detection module 12 disposed at the main body 11, a central processing module 20 electrically connected with the radar detection module 12, and a first message transmission module 13 electrically connected with the central processing module 20.

The central processing module 20 comprises a speed calculation unit 21 and a threshold determination unit 23. In an embodiment of the present invention, the radar detection module 12 includes a radar array antenna, and the operation frequency of the radar detection module 12 ranges from 10 to 81 GHz, which is optional according to the user selection. Also, due to the difference between the frequencies of radar, detectable distance varies as well. The central processing module 20 further includes a direction calculation unit 22. The central processing module 20 receives a detection signal from the radar detection module 12, and acquires an approaching speed information and an approaching direction information through the speed calculation unit 21 and the direction calculation unit 22, respectively. For example, the central processing module 20 is allowed to be a microcontroller unit (MCU), which is provided with functions including calculation, memory storage, and digital-to-analog conversion. The user is able to set up the detection device 10 by use of a human machine interface (not shown), so as to customize the warning level according to user demand.

The threshold determination unit 23 determines if the warning shall be sent to the first message transmission module 13 according to the approaching speed information and the approaching direction information. For example, a general save distance is suggested to be in a distance range (meters), which is defined as “the hourly speed divided by two (kilometers per hour/2)”. When the hourly speed is at 80 kilometers (km/h), the safe distance shall be more than 40 meters. In other words, when the hourly speed of the approaching object 50 is at 80 kilometers, the threshold determination unit 23 is set to send the warning when the save distance between the approaching object 50 and detection device 10 the is smaller than 40 meters. Nevertheless, the threshold determination unit 23 is allowed to be adjusted according to the real situation. The warning device 30 includes a second message transmission module 31 and a warning module 32 connected with the second message transmission module 31. For example, the warning module 32 is allowed to provide a warning with sound, light, or vibration, such as a buzzer or an LED flash light. Furthermore, according to the provided approaching direction information, the warning device 30 is also able to notify the user of the approaching direction of the approaching risk through image or sound, facilitating a better warning effect.

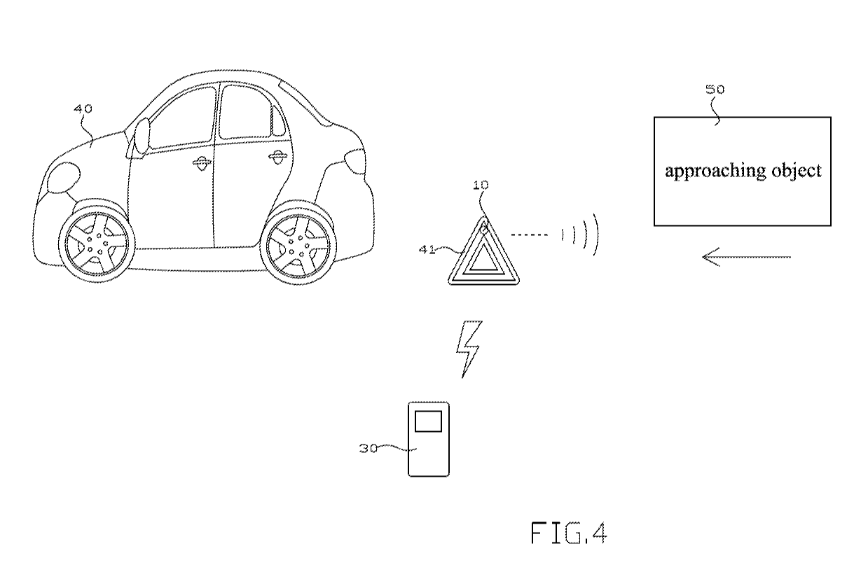

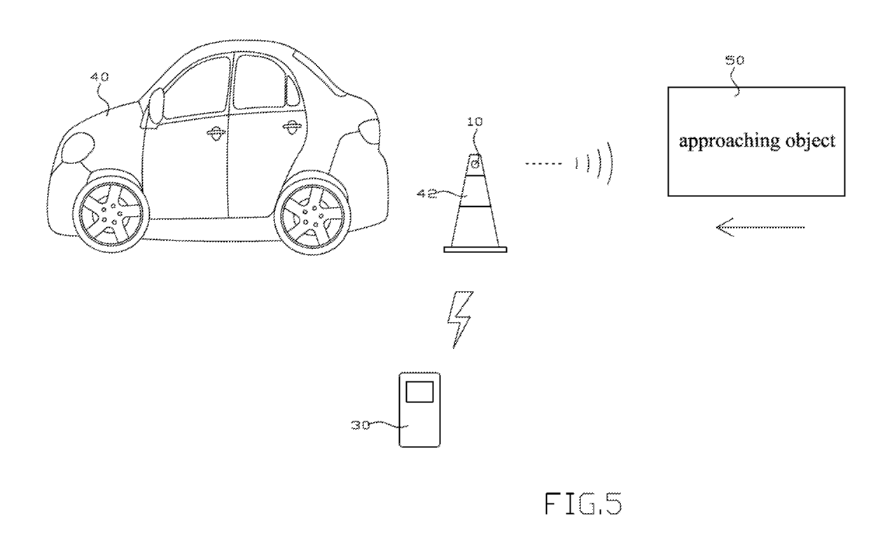

It shall be noted that, referring to FIG. 3 to FIG. 5, the main body 11 is allowed to be but not limited to a mobile vehicle body 40, a triangular warning sign 41, a traffic cone 42, or a roadside barricade. In other words, the main body 11 of the present invention is allowed to be object which remains in a static situation during the detection. Alternatively, the main body 11 is allowed to be an object which is clamped or adhered to be fixed, such as being movably attached to a mobile vehicle body or object. In an embodiment of the present invention, the first message transmission module 13 is electrically connected with the second message transmission module 31 through a wireless transmission structure, which is allowed to be a Bluetooth, WI-FI, or other signal transmission structures applying radio frequency.

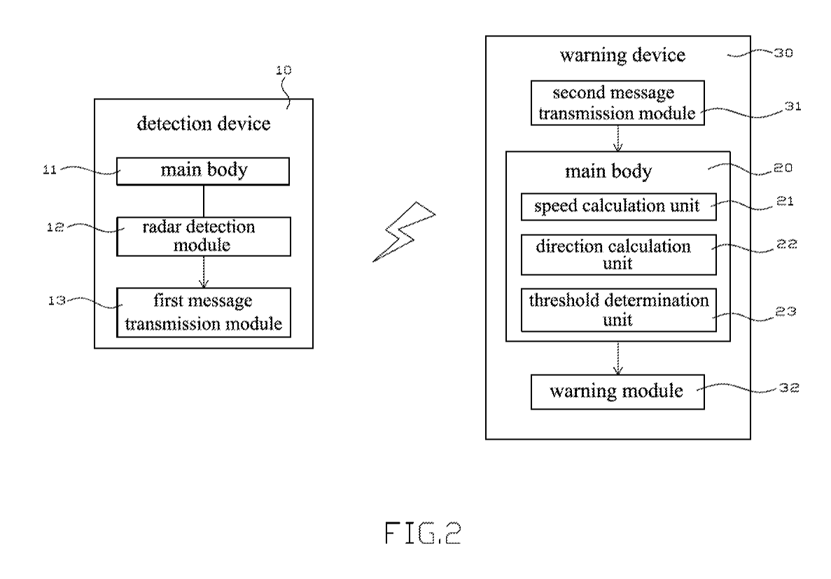

On the other hand, the central processing module 20 is also allowed to be disposed in the warning device 30, such that the detection device 10 is simply applied for detecting and sending a detected signal. Therefore, referring to FIG. 2, the warning system for high speed approaching detection in accordance with another embodiment of the present invention comprises a statically placed detection device 10 and a warning device 30 electrically connected with the detection device 10. The detection device 10 comprises a main body 11, a radar detection module 12 disposed at the main body 11, and a first message transmission module 13 electrically connected with the radar detection module 12. The warning device 30 includes a second message transmission module 31, a central processing module 20 electrically connected with the second message transmission module 31, and a warning module 32 electrically connected with the central processing module 20. The central processing module 20 includes a speed calculation unit 21 and a threshold determination unit 23. The central processing module 20 receives a detection signal from the radar detection module 12 through the second message transmission module 31, and acquires an approaching speed information of an approaching object 50 through the speed calculation unit 21. The threshold determination unit 23 determines if the warning shall be sent to the warning module 32 according to the approaching speed information.

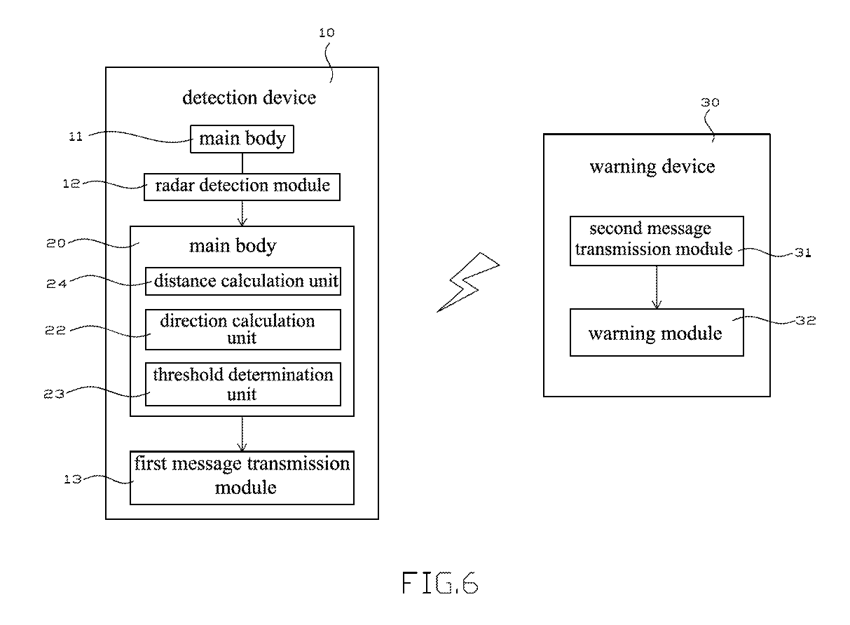

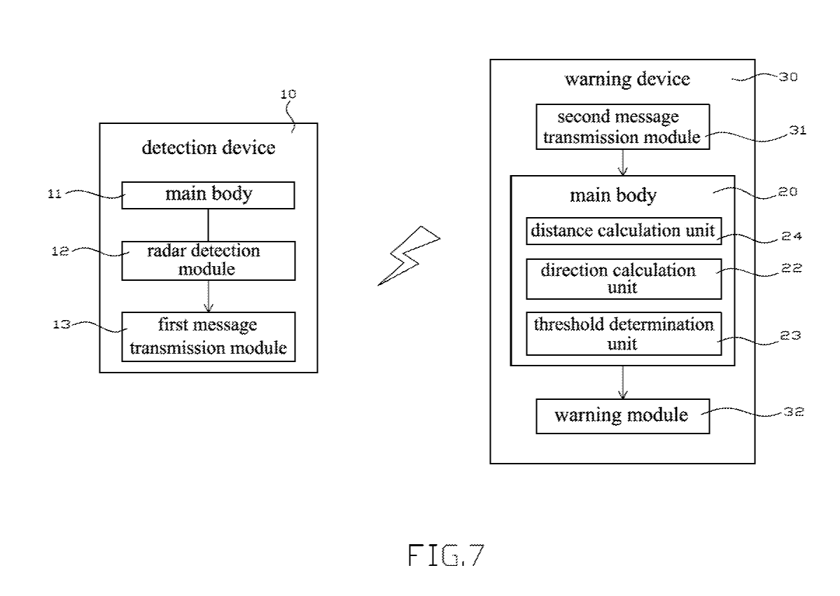

Further, referring to FIG. 6 and FIG. 7, in the third and fourth embodiments of the present invention, the speed calculation unit 21 from the first and second embodiments is replaced by a distance calculation unit 24, so as to acquire an approaching distance information of the approaching object 50. The threshold determination unit 23 determines if the warning shall be sent to the first message information transmission module 13 according to the approaching distance information. It shall be noted that the difference between the third and fourth embodiments only lies in the position of the central processing module 20. Referring to FIG. 6, the central processing module 20 is disposed in the detection device 10, while the central processing module 20 in FIG. 7 is disposed in the warning device 30. Such two embodiments illustrate that the necessity of sending the warning is able to be determined based on the distance between the approaching object 50 and the detection device 10. On the other hand, although the first and second embodiments are meant to calculate the speed of the approaching object 50, the distance between the approaching object 50 and the detection device 10 is allowed to be determined at first hand, such that the duration is subsequently applied in the calculation to acquire the approaching speed information.

With the foregoing configuration, the present invention achieves following advantages.

First, by detecting a risky approaching object with the detection device under a static situation, a warning is provided to the user unaware of the approaching object.

Further, applying the central processing module to determine if a risky object is approaching according to the approaching speed or approaching distance, so as to send the warning through the warning device, thereby notifying the user of a fast approaching risky object.

Further, with the connection between the detection device and the warning device through the wireless connection structure, the mobility of the system is facilitated, and the user is allowed to be notified by the warning even when the user is separated from the detection by a certain distance, such that the user is able to react as early as possible.

Further, with the application of the detection device, the safety of a broken down vehicle which awaits for aid at the roadside is improved.

Further, with the application of the detection device, a pre-warning function is provided for the policemen executing a roadside check.

Further, by further determining the object approaching direction through the direction calculation unit, a possibly collided direction and position is pre-determined, so as to prevent a blind spot accident upon the user from occurring.

Although particular embodiments of the invention have been described in detail for purposes of illustration, various modifications and enhancements may be made without departing from the spirit and scope of the invention.

Accordingly, the invention is not to be limited except as by the appended claims.

What is claimed is:

1. A warning system for high speed approaching detection, comprising:
a statically placed detection device, the detection device including a main body, a radar detection module disposed at the main body, a central processing module electrically connected with the radar detection module, and a first message transmission module electrically connected with the central processing module; the central processing module includes a speed calculation unit and a threshold determination unit; the central processing module receives a detection signal from the radar detection module and acquires an approaching speed information of an approaching object through the speed calculation unit; the threshold determination unit determines if a warning is to be sent to the first message transmission module according to the approaching speed information; and
a warning device electrically connected with the detection device, the warning device including a second message transmission module and a warning module connected with the second message transmission module.

2. The warning system of claim 1, wherein the first message transmission module is electrically connected with the second message transmission module through a wireless transmission structure.

3. The warning system of claim 1, wherein the central processing module further includes a direction calculation unit, so as to calculate to acquire an approaching direction information of the approaching object, and the approaching direction information is then provided to the threshold determination unit.

4. The warning system of claim 1, wherein the main body is selected from the group consisting of a triangular warning sign, a traffic cone, a roadside barricade, and a vehicle body.

5. A warning system for high speed approaching detection, comprising:
a statically placed detection device, the detection device including a main body, a radar detection module disposed at the main body, and a first message transmission module electrically connected with the radar detection module; and
a waning device electrically connected with the detection device, the warning device including a second message transmission module, a central processing module electrically connected with the second message transmission module, and a warning module electrically connected with the central processing module; the central processing module includes a speed calculation unit and a threshold determination unit; the central processing module receives a detection signal from the radar detection module through the second message transmission module and acquires an approaching speed information of an approaching object through the speed calculation unit; the threshold determination unit determines if a warning is to be sent to the warning module according to the approaching speed information.

6. The warning system of claim 5, wherein the first message transmission module is electrically connected with the second message transmission module through a wireless transmission structure.

7. The warning system of claim 5, wherein the central processing module further includes a direction calculation unit, so as to calculate to acquire an approaching direction information of the approaching object, and the approaching direction information is then provided to the threshold determination unit.

8. The warning system of claim 5, wherein the main body is selected from the group consisting of a triangular warning sign, a traffic cone, a roadside barricade, and a vehicle body.

9. A warning system for high speed approaching detection, comprising:
a statically placed detection device, the detection device including a main body, a radar detection module disposed at the main body, a central processing module electrically connected with the radar detection module, and a first message transmission module electrically connected with the central processing module; the central processing module includes a distance calculation unit and a threshold determination unit; the central processing module receives a detection signal from the radar detection module and acquires an approaching distance information of an approaching object through the distance calculation unit; the threshold determination unit determines if a warning is to be sent to the first message transmission module according to the approaching distance information; and
a warning device electrically connected with the detection device, the warning device including a second message transmission module and a warning module connected with the second message transmission module.

10. The warning system of claim 9, wherein the first message transmission module is electrically connected with the second message transmission module through a wireless transmission structure.

11. The warning system of claim 9, wherein the central processing module further includes a direction calculation unit, so as to calculate to acquire an approaching direction information of the approaching object, and the approaching direction information is then provided to the threshold determination unit.

12. The warning system of claim 9, wherein the main body is selected from the group consisting of a triangular warning sign, a traffic cone, a roadside barricade, and a vehicle body.

13. A warning system for high speed approaching detection, comprising:
a statically placed detection device, the detection device including a main body, a radar detection module disposed at the main body, and a first message transmission module electrically connected with the radar detection module; and
a waning device electrically connected with the detection device, the warning device including a second message transmission module, a central processing module electrically connected with the second message transmission module, and a warning module electrically connected with the central processing module; the central processing module includes a distance calculation unit and a threshold determination unit; the central processing module receives a detection signal from the radar detection module through the second message transmission module and acquires an approaching distance information of an approaching object through the distance calculation unit; the threshold determination unit determines if a warning is to be sent to the warning module according to the approaching distance information.

14. The warning system of claim 13, wherein the first message transmission module is electrically connected with the second message transmission module through a wireless transmission structure.

15. The warning system of claim 13, wherein the central processing module further includes a direction calculation unit, so as to calculate to acquire an approaching direction information of the approaching object, and the approaching direction information is then provided to the threshold determination unit.

16. The warning system of claim 13, wherein the main body is selected from the group consisting of a triangular warning sign, a traffic cone, a roadside barricade, and a vehicle body.
